(19) United States
(12) Patent Application Publication
(10) Pub. No.: US 2008/0070607 A1
(43) Pub. Date: Mar. 20, 2008

(54) APPARATUS AND METHOD FOR TRANSMITTING/RECEIVING BINARY DATA IN SHORT MESSAGE SYSTEM

(75) Inventor: Young-Taeck SONG, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/857,992

(22) Filed: Sep. 19, 2007

(30) Foreign Application Priority Data
Sep. 19, 2006 (KR) 2006-0090809

(51) Int. Cl. H04Q 7/20

(52) U.S. Cl. 455/466

(57) ABSTRACT

Provided is an apparatus and method for transmitting/receiving binary data in a short message system. The short message system includes a transmitting apparatus and a receiving apparatus. The transmitting apparatus converts the binary data into conversion binary data such that the binary data is not expressed as a character string, and includes and transmits the conversion binary data in a short message. The receiving apparatus restores the conversion binary data to the original binary data when receiving the short message including the conversion binary data.

### PRIORITY

This application claims priority under 35 U.S.C. § 119 to an application filed in the Korean Intellectual Property Office on Sep. 19, 2006 and assigned Serial No. 2006-90809, the contents of which are incorporated herein by reference.

### BACKGROUND OF THE INVENTION

1. Field of the Invention

The present invention relates generally to a short message system for transmitting/receiving binary data, and in particular, to an apparatus and method for transmitting/receiving binary data and disabling output of binary data to a display unit of a receiving apparatus in a short message system.

2. Description of the Related Art

In recent years, mobile terminals such as mobile telephones and Personal Digital Assistants (PDAs) have been widely used. The mobile terminal is constantly increasing in utility, as evidenced by recently developed functions such as photographing an image or a moving picture by a digital camera, viewing a digital multimedia broadcast, editing a document, playing a game, navigating, and transmitting/receiving a short message and a multimedia message attached with a photographed image or moving picture, as well as simple telephony or schedule management.

As a result of the increased utility of the mobile communication terminal, a demand for data transmission/reception based on an application technology of the mobile communication terminal has also increased. The demand has been met with a small cost by data transmission using a short message that is commonly used in the mobile communication terminal.

A Short Message Service (SMS) system is a standard system for sending a character. As the SMS system converts a specific character string into emoticon and transmits the emoticon, it processes a partial character to data or a whole message to binary data and sends the processed data. In this case, there is an advantage that a mobile phone manufacturer as well as a service provider can realize a function of transmitting binary data, not a character string, by the conventional SMS system without building up a separate communication based infrastructure.

However, if binary data is loaded and sent on a short message to a terminal that does not support binary data, it is seen in a broken character string format. Thus, a user may misunderstand binary data as a spam character or a terminal error. This is because binary data partially complies with a character expression standard even though it is not really data for expressing a character. Therefore, an error occurs such that a terminal outputs binary data as a character because it cannot identify the binary data.

To solve this problem, the SMS system transmitting binary data should be separately operated. However, separately operated systems are expensive, and thus it is meaningless to purposely use the SMS system.

Accordingly, there is a demand for an apparatus and method for disabling output of a broken character string from the terminal not supporting binary data without additionally operating a separate system.

### SUMMARY OF THE INVENTION

An aspect of the present invention is to substantially solve at least the above problems and/or disadvantages and to provide at least the advantages below. Accordingly, an aspect of the present invention is to provide an apparatus and method for transmitting/receiving binary data in a short message system.

An aspect of the present invention is to provide an apparatus and method for transmitting/receiving binary data, and disabling output of binary data to a display unit of a receiving apparatus in a short message system.

An aspect of the present invention is to provide a transmitting apparatus and method in a short message system, for converting binary data in such a manner that it is not expressed as a character, and including and transmitting the converted binary data in a short message.

An aspect of the present invention is to provide a receiving apparatus and method for restoring conversion binary data, which is obtained by converting binary data in such a manner that it is not expressed as a character, to the original binary data in a short message system.

According to the present invention, there is provided a short message system for transmitting/receiving binary data. The system includes a transmitting apparatus for converting the binary data into conversion binary data that is not expressed as a character string, and including and transmitting the conversion binary data in a short message, and a receiving apparatus for restoring the conversion binary data to the original binary data when receiving the short message including the conversion binary data.

According to the present invention, there is provided an apparatus for transmitting binary data in a short message system. The apparatus includes a binary converter for converting the binary data to be transmitted into data within a character-undefined region complying with a character string expression standard, such that the binary data is not expressed as a character, and generating conversion binary data, a message generator for generating a short message including the conversion binary data, a communication unit for transmitting the short message generated in the message generator, and a controller for converting the binary data by the binary converter, generating the short message including the conversion binary data by the message generator, and transmitting the generated short message to a receiving apparatus by the communication unit.

According to the present invention, there is provided a method for transmitting binary data in a short message system. The method includes converting the binary data to be transmitted into data within a character-undefined region complying with a character string expression standard, such that the binary data is not expressed as a character, and generating conversion binary data, generating a short message including the conversion binary data, and transmitting the generated short message.

According to the present invention, there is provided a method for receiving binary data in a short message system. The method includes checking whether the short message includes conversion binary data when receiving a short message, and restoring the conversion binary data to the original binary data when it is checked that the short message includes the conversion binary data.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a transmitting and a receiving apparatus of a short message system for transmitting/receiving binary data so as not to output the binary data as a character string according to the present invention;

FIG. 2 illustrates architecture of a short message for transmitting/receiving binary data so as not to output the binary data as a character string according to the present invention;

FIG. 3 illustrates a procedure of converting and transmitting binary data by the transmitting apparatus of the short message system so as not to output the binary data as a character string according to the present invention;

FIG. 4 illustrates a conversion region for converting binary data so as not to output the binary data as a character string in the transmitting apparatus of the short message system according to the present invention; and

FIG. 5 illustrates a procedure of receiving and processing a short message including binary data, which is converted so as not to output the binary data as a character string, by the receiving apparatus of the short message system according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail for the sake of clarity and conciseness.

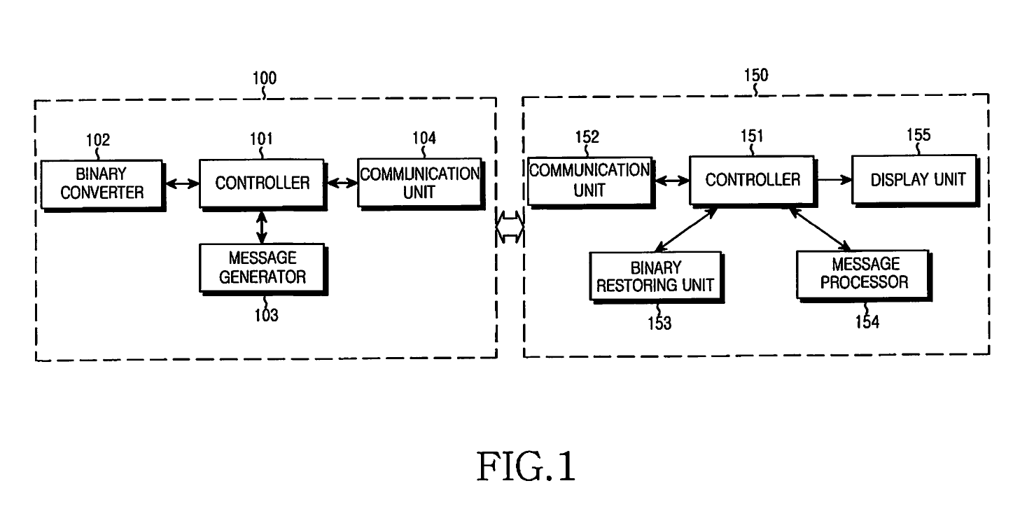

FIG. 1 illustrates a transmitting apparatus and a receiving apparatus of a short message system for transmitting/receiving binary data so as not to output the binary data as a character string according to the present invention.

Referring to FIG. 1, the inventive short message system includes the transmitting apparatus 100 and the receiving apparatus 150. The transmitting apparatus 100 includes a controller 101, a binary converter 102, a message generator 103 and a communication unit 104. The receiving apparatus 150 includes a controller 151, a communication unit 152, a binary restoring unit 153, a message processor 154 and a display unit 155.

The transmitting apparatus 100 converts binary data such that it is not expressed as a character string and transmits the converted binary data. The transmitting apparatus 100 can be a service provider server or a mobile communication terminal to transmit binary data.

The binary converter 102 converts binary data into data within a character-undefined region complying with a character string expression standard, such that the data is not expressed as a character.

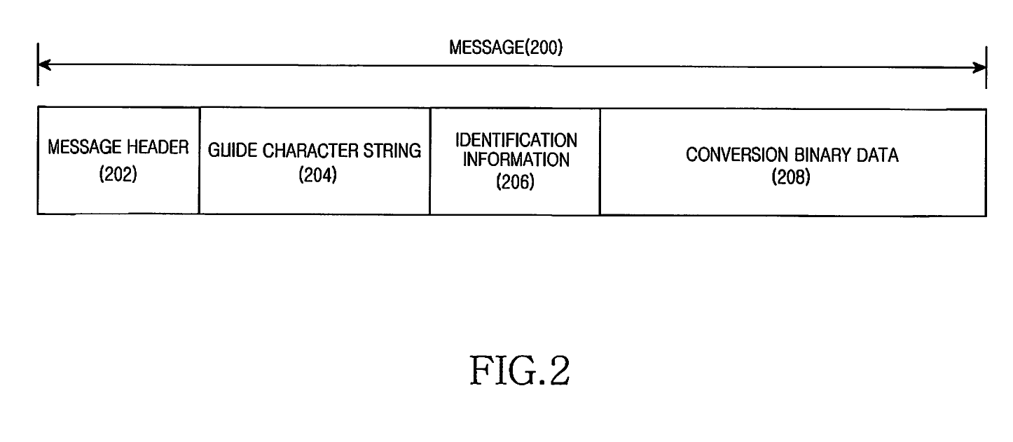

The message generator 103 generates a short message 200 having architecture of FIG. 2, which illustrates the architecture of the short message for transmitting/receiving binary data so as not to output the binary data as a character string according to the present invention.

Referring to FIG. 2, the short message 200 includes a message header 202, a guide character string 204, identification information 206 and conversion binary data 208.

The message header 202 includes information complying with a short message service standard, such as origination and destination information. The guide character string 204 is outputted for a terminal that is unable to receive binary data by a short message. The identification information 206 is for identifying that the short message 200 includes binary data. The identification information 206 is also expressed by information existing in a region out of the character string expression standard. The conversion binary data 208 represents binary data converted by the binary converter 102.

The communication unit 104 transmits the short message 200 generated by the message generator 103 to the receiving apparatus 150 via a short message service server.

Upon receipt of a request for transmitting binary data, the controller 101 converts the binary data by the binary converter 102, generates the short message 200 including the conversion binary data 208 by the message generator 103 and transmits the generated short message 200 to the receiving apparatus 150 via the communication unit 104.

The receiving apparatus 150 receives conversion binary data from the transmitting apparatus 100, restores the conversion binary data to original binary data and performs a corresponding function suitable to a use of the original binary data.

In a reception mode, the communication unit 152 receives a radio frequency signal through an antenna (not shown) and processes the received signal by frequency down, despreading and channel decoding. In a transmission mode, the communication unit 152 processes data by channel decoding, spreading and frequency up, and transmits the processed data through the antenna. The communication unit 152 receives a short message including conversion binary data in addition to a general function according to the present invention.

The binary restoring unit 153 receives a short message 200 via the communication unit 152 and restores conversion binary data 208 included in the received short message 200 to original binary data.

The message processor 154 processes and outputs a character string included in a received short message to the display unit 155 if the short message excludes binary data.

Upon receipt of a short message via the communication unit 152, the controller 151 checks whether the received short message includes conversion binary data 208. If it is checked that the received short message includes the conversion binary data 208, the controller 151 controls the binary restoring unit 153 to restore the conversion binary data 208 to original binary data and performs a corresponding function of the original binary data. However, if it is checked that the received short message does not include the conversion binary data 208, the controller 151 identifies the received short message as a general short message including only a character string and outputs the included character string to the display unit 155 through the message processor 154.

If the short message 200 including the conversion binary data 208 were received by a conventional mobile communication terminal not equipped with the binary restoring unit 153, it would only output the guide character string 204, and not the conversion binary data 208 and the identification information 206 existing in the region out of the character string expression standard.

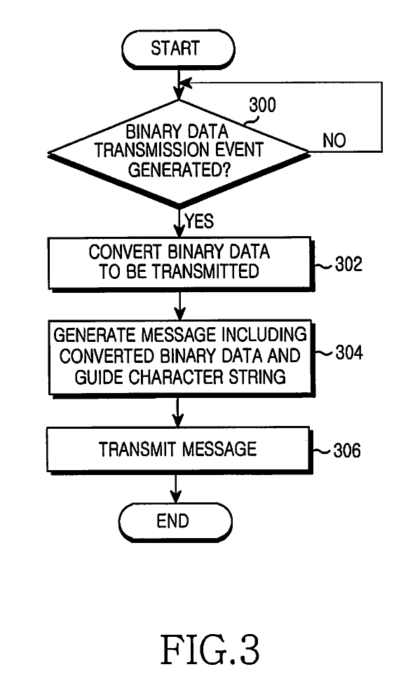

FIG. 3 illustrates a procedure of converting and transmitting binary data by the transmitting apparatus of the short message system so as not to output the binary data as a character string according to the present invention.

Referring to FIG. 3, the transmitting apparatus 100 checks whether it detects generation of a binary data transmission event in Step 300. If it does, then the transmitting apparatus 100 converts binary data to be transmitted into data within the character-undefined region complying with the character string expression standard, such that the binary data is not expressed as a character, and generates conversion binary data 208 in Step 302. In Step 304, the transmitting apparatus 100 generates a short message 200 including the conversion binary data 208 of FIG. 2 and transmits the generated short message 200 in Step 306.

A method for converting binary data and generating conversion binary data in Step 302 varies depending on the character string expression standard. First, an example of conversion based on American Standard Code for Information Interchange (ASCII) standard will be described. Among ASCII character strings, a hexadecimal value ranging from 0x1 to 0x20 is not outputted. In other words, binary data having random values is converted into data having values ranging from 0x1 to 0x20.

A process of generating conversion binary data using ASCII will be described. Binary data is processed as a bit stream and is divided into 5-bit groups. A three-bit value of 0B000 is attached in front of each of the divided groups. By doing so, each of the divided groups is equal to 8-bit data having a value of 0x0 to 0x1F. Here, the value of 0x0 is converted into the value of 0x20 (space).

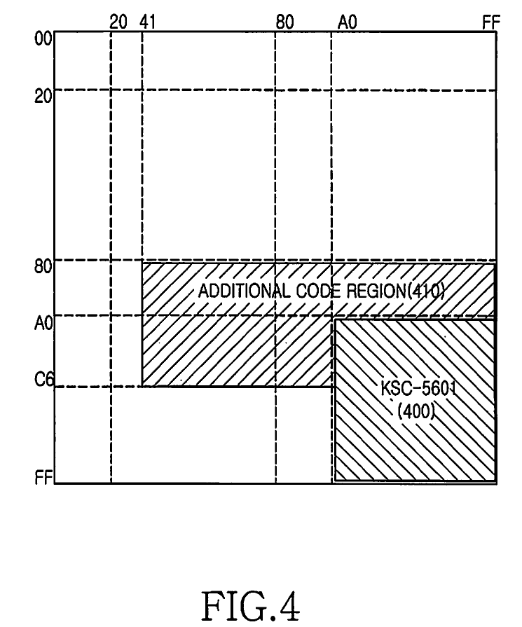

Second, an example of conversion based on Korean Standard Code (KSC)-5601 will be described. A character expression range of KSC-5601 is shown in FIG. 4, which illustrates a conversion region for converting binary data so as not to output the binary data as a character string in the transmitting apparatus of the short message system according to the present invention.

Referring to FIG. 4, a KSC-5601 region 400 and an additional code region 410 are indicated by respective shaded regions. The KSC-5601 region 400 and the additional code region 410 are character-defined regions in which data is outputted as characters. Other regions are character-undefined regions in which data is not outputted to the display unit. During a conversion process based on KSC-5601, data within the region 400 is mapped to data of the non-marked, i.e., character-undefined regions.

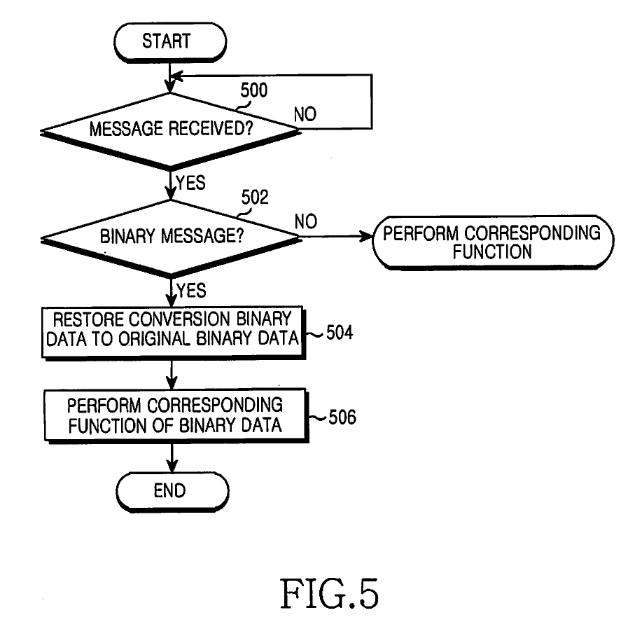

FIG. 5 illustrates a procedure of receiving and processing a short message including binary data, which is converted so as not to output the binary data as a character string, by the receiving apparatus of the short message system according to the present invention.

Referring to FIG. 5, the receiving apparatus 150 checks whether it detects receipt of a short message in Step 500. If it does, the receiving apparatus 150 checks whether the short message includes conversion binary data 208 by checking whether there exists identification information 206 in Step 502. If the check result is that the short message excludes the conversion binary data 208, the receiving apparatus 150 performs a general corresponding function.

On the contrary, if the check result is that the short message includes the conversion binary data 208, the receiving apparatus 150 converts and restores the conversion binary data 208 to original binary data in Step 504. The receiving apparatus 150 performs a corresponding function of the original binary data in Step 506.

As described above, the present invention provides an apparatus and a method for transmitting/receiving binary data in the short message system. The transmitting apparatus converts binary data into data within the character-undefined region complying with the character string expression standard so as not to express the binary data as a character and transmits the converted binary data. Thus, the present invention prevents a meaningless character string, which may be caused by binary data, from being output to the display unit of the receiving apparatus. The present invention also disables output of a meaningless character string, which may be caused by binary data received using a short message, in a terminal that is unable to process binary data.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A short message system for transmitting/receiving binary data, the system comprising:
a transmitting apparatus for converting the binary data into conversion binary data such that the binary data is not expressed as a character string, and including and transmitting the conversion binary data in a short message; and
a receiving apparatus for restoring the conversion binary data to the original binary data when receiving the short message including the conversion binary data.

2. An apparatus for transmitting binary data in a short message system, the apparatus comprising:
a binary converter for converting the binary data to be transmitted into data within a character-undefined region complying with a character string expression standard, such that the binary data is not expressed as a character, and generating conversion binary data;
a message generator for generating a short message including the conversion binary data;
a communication unit for transmitting the short message generated in the message generator; and
a controller for performing a control of converting the binary data by the binary converter, generating the short message including the conversion binary data by the message generator, and transmitting the generated short message to a receiving apparatus by the communication unit.

3. The apparatus of claim 2, wherein the message generator generates the short message including a message header, a guide character string, identification information and the conversion binary data.

4. The apparatus of claim 2, wherein when converting the binary data into the conversion binary data expressed using American Standard Code for Information Interchange (ASCII), the binary converter processes the binary data as a bit stream, divides the binary data into 5-bit groups, attaches a hexadecimal value of 0B000 in front of each of the divided groups, converts each of the divided groups into a hexadecimal value ranging from 0x0 to 0x1F, and converts the value of 0x0 into a value of 0x20.

5. The apparatus of claim 2, wherein when converting the binary data into the conversion binary data expressed using Korean Standard Code (KSC)-5601, the binary converter maps and converts the binary data into data within a character-undefined region complying with KSC-5601.

6. The apparatus of claim 2, wherein the receiving apparatus includes a binary restoring unit for restoring the conversion binary data to the original binary data.

7. The apparatus of claim 3, wherein the receiving apparatus outputs only the guide character string when the apparatus is unable to process the binary data.

8. A method for transmitting binary data in a short message system, the method comprising:
converting the binary data to be transmitted into data within a character-undefined region complying with a character string expression standard, such that the binary data is not expressed as a character, and generating conversion binary data;
generating a short message including the conversion binary data; and
transmitting the generated short message.

9. The method of claim 8, wherein the short message includes a message header, a guide character string, identification information and the conversion binary data.

10. The method of claim 8, wherein when generating the conversion binary data, the binary data is processed as a bit stream and is divided into 5-bit groups, a hexadecimal value of 0B000 is attached in front of each of the divided groups, each of the divided groups is converted into a hexadecimal value ranging from 0x0 to 0x1F, and the value of 0x0 is converted into a value of 0x20, when the binary data is converted into the conversion binary data expressed using American Standard Code for Information Interchange (ASCII).

11. The method of claim 8, wherein when generating the conversion binary data, the binary data is mapped and converted into data within a character-undefined region complying with Korean Standard Code (KSC)-5601, when the binary data is converted into the conversion binary data expressed using KSC-5601.

12. A method for receiving binary data in a short message system, the method comprising:
checking whether the short message includes conversion binary data when receiving a short message; and
restoring the conversion binary data to original binary data when it is checked that the short message includes the conversion binary data.

13. The method of claim 12, wherein the short message includes a message header, a guide character string, identification information and the conversion binary data.

14. The method of claim 13, wherein checking whether the short message includes the conversion binary data determines that there exists the conversion binary data when there exists identification information in the short message.

15. The method of claim 13, wherein a receiving apparatus outputs only the guide character string when the apparatus is unable to process the binary data.
